(19) United States
(12) Patent Application Publication
(10) Pub. No.: US 2025/0215992 A1
(43) Pub. Date: Jul. 3, 2025

(54) LIQUEFIED PETROLEUM GAS FAUCET

(71) Applicant: Avishai EDRI, Bat Yam (IL)

(72) Inventor: Tomer SHAUL, Jerusalem (IL)

(21) Appl. No.: 18/856,874

(22) PCT Filed: Feb. 8, 2023
(86) PCT No.: PCT/IL2023/050135

§ 371 Date: Oct. 14, 2024

(30) Foreign Application Priority Data
Feb. 9, 2022 (IL) 290484

(51) Int. Cl. F16K 31/05; F16K 35/10; F17D 3/01

(52) U.S. Cl. CPC F16K 31/055; F16K 35/10; F17D 3/01

(57) ABSTRACT

A liquefied petroleum gas (LPG) faucet, comprising: an electro-mechanical device for sliding a pin; and an electric circui, for controlling said electro-mechanical device, wherein opening said faucet requires a manual physical operation, whereas closing said faucet is applicable only by controlling said electric circuit.

### TECHNICAL FIELD

The invention relates to the field of liquefied petroleum gas piping. More particularly, the invention relates to a method and faucet therefor.

### BACKGROUND

FIG. 1 depicts a prior art liquefied petroleum gas (LPG) faucet at the open state.

A conventional LPG faucet 23 includes a rotational arm/handle 24, for manually closing and opening the gas passage 21.

The term “open state” refers to the state gas passage 21 is open, to allow gas flow.

The term “closed state” refers to the state gas passage 21 is closed, to disallow gas flow.

However, any person might open and close gas passage 21, being dangerous in cases that a gas professional decides that gas passage 21 must be closed.

There is a long felt need to provide a solution to the above-mentioned and other problems of the prior art.

### SUMMARY

A liquefied petroleum gas faucet, including:
a solenoid; and
an electric circuit, for sliding the solenoid;
   wherein opening the faucet requires manual physical operation, whereas
closing the faucet is applicable only by controlling the electric circuit.

### BRIEF DESCRIPTION OF THE DRAWINGS

Embodiments, features, and aspects of the invention are described herein in conjunction with the following drawings:

FIG. 1 depicts a prior art liquefied petroleum gas (LPG) faucet at the open state.

FIG. 2 depicts a liquefied petroleum gas (LPG) faucet according to one embodiment of the invention, at the open state.

FIG. 3 shows the open state.

FIG. 4 depicts the LPG faucet of FIG. 2 disassembled.

FIG. 5 depicts the closing operation of the LPG faucet of FIG. 2.

FIG. 6 shows the closed state.

FIG. 7 depicts locking of the closing of the LPG faucet of FIG. 3.

FIG. 8 depicts the LPG faucet according to another embodiment, at the open state.

FIG. 9 depicts the LPG faucet of FIG. 8 at the closed state.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

FIG. 2 depicts a liquefied petroleum gas (LPG) faucet according to one embodiment of the invention, at the open state.

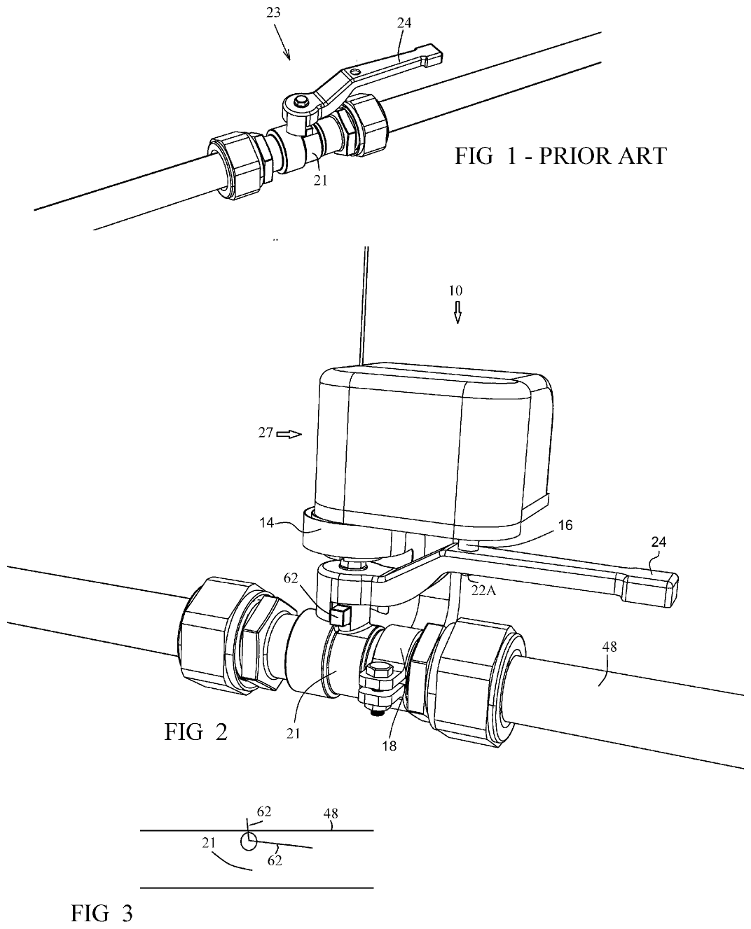

Commonly, gas passage 21 is open in case handle 24 is disposed parallel to pipe, as depicted in FIG. 1.

FIG. 3 shows the open state.

At the open state of FIG. 2, handle 24 disposes a pipe blocking element 62 to open pipe 48.

Referring again to FIG. 2, An LPG faucet 10 according to one embodiment, includes a spring 14 being normally tensed to rotate handle 24 to close gas passage 21, against the open state of FIG. 3.

However, at the opened state of faucet 10, a pin 16 locks handle 24 to maintain the open state, such as by a pin 16 entering a hole 22A of handle 24.

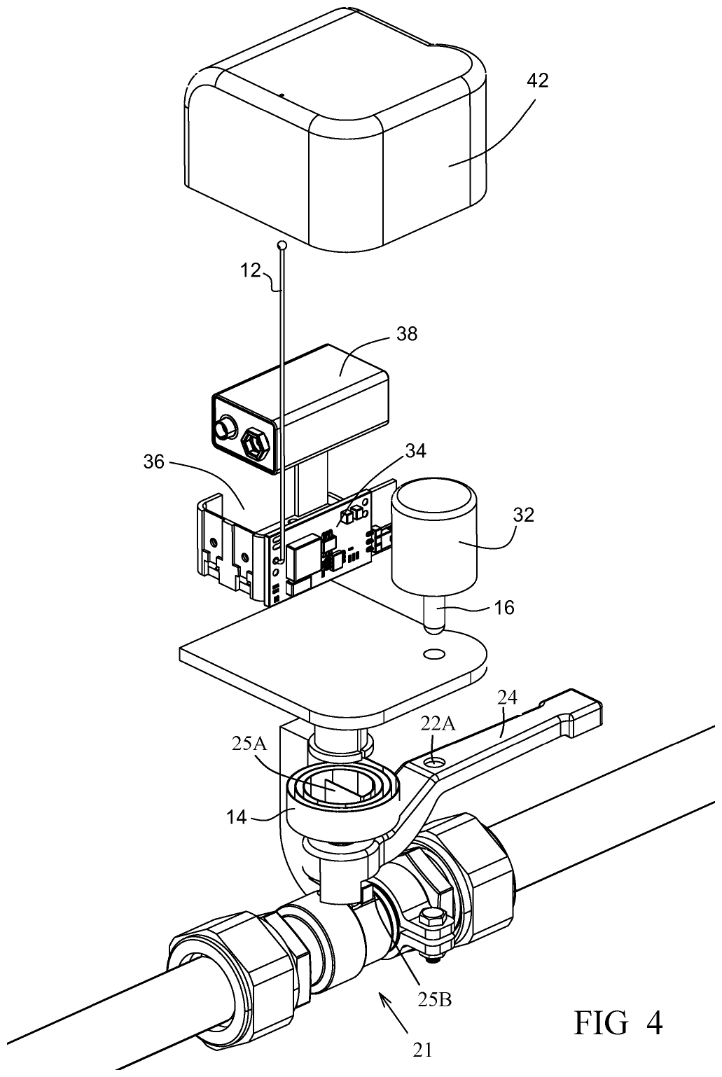

FIG. 4 depicts the LPG faucet of FIG. 2 disassembled.

Pin 16 is slideable only by a solenoid 32, controlled by a circuit 36.

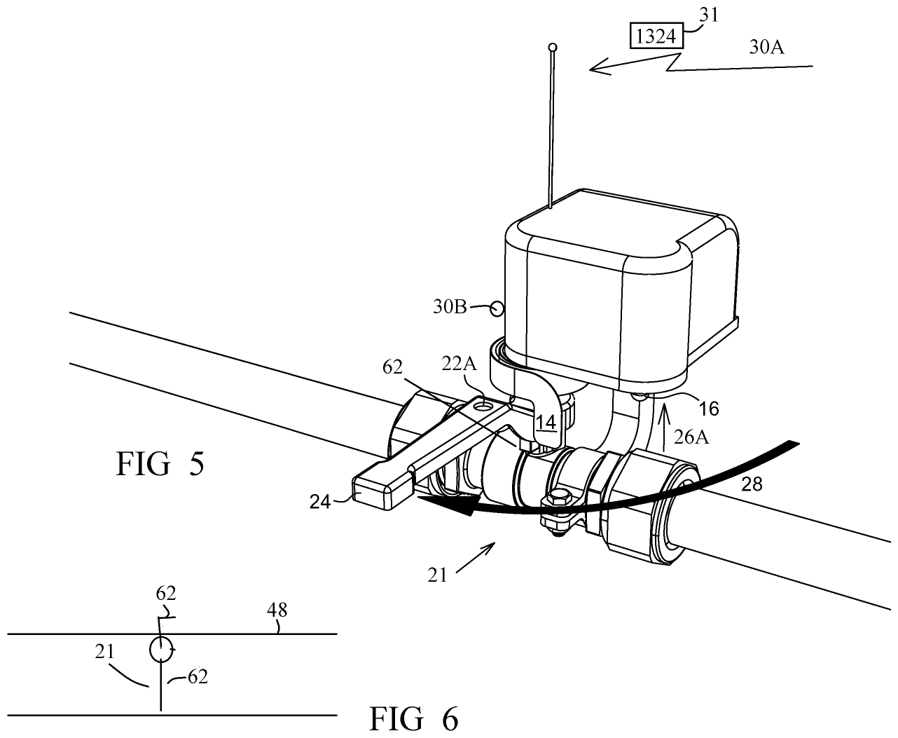

FIG. 5 depicts the closing operation of the LPG faucet of FIG. 2.

Operation of solenoid 32 (FIG. 4) slides (26A) pin 16 to remove it from hole 22A. Then, spring 14 rotates handle 24 to close gas passage 21.

Thus, closing of gas passage 21 is available only by electrical means, such as by wireless transmission 30A, which may be encoded (31), or by a sensor 30B, such as an LPG leak sensor controlling circuit 36 (FIG. 4).

Thus, the gas professional only, possessing password 31, can remotely close gas passage 21, upon being warned. However, the gas professional cannot remotely open gas passage 21, but rather must physically visit and check for the reason of the warning.

FIG. 6 shows the closed state.

At the closed state of FIG. 5, handle 24 disposes blocking element 62 to close pipe 48.

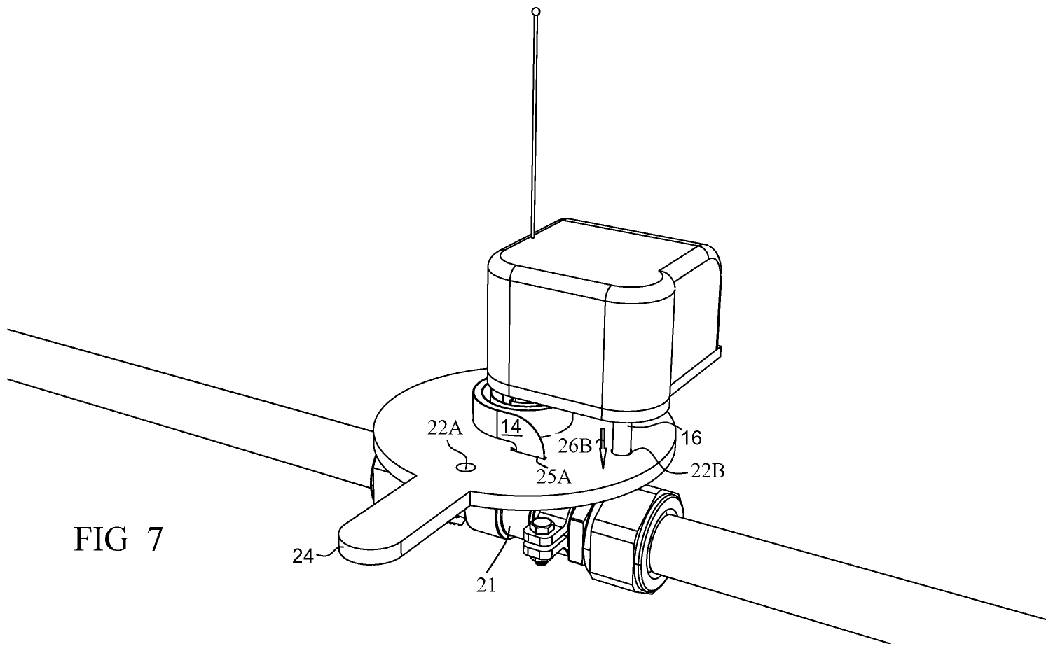

FIG. 7 depicts locking of the closing of the LPG faucet of FIG. 3.

Once handle 24 has closed gas passage 21, solenoid 32 (FIG. 4) may slide (26B) pin 16 inwards, for locking handle 24 at the closed state, such as by entering a hole 22B of handle 24.

Thus, the gas professional may exclusively and remotely close gas passage 21. This operation may as well lock the closed state, for ensuring that nobody else can open the gas passage.

In contrast, LPG faucet 10 (FIG. 3) does not allow the gas professional to remotely open gas passage 21, and the gas professional must physically visit LPG faucet to open gas passage 21.

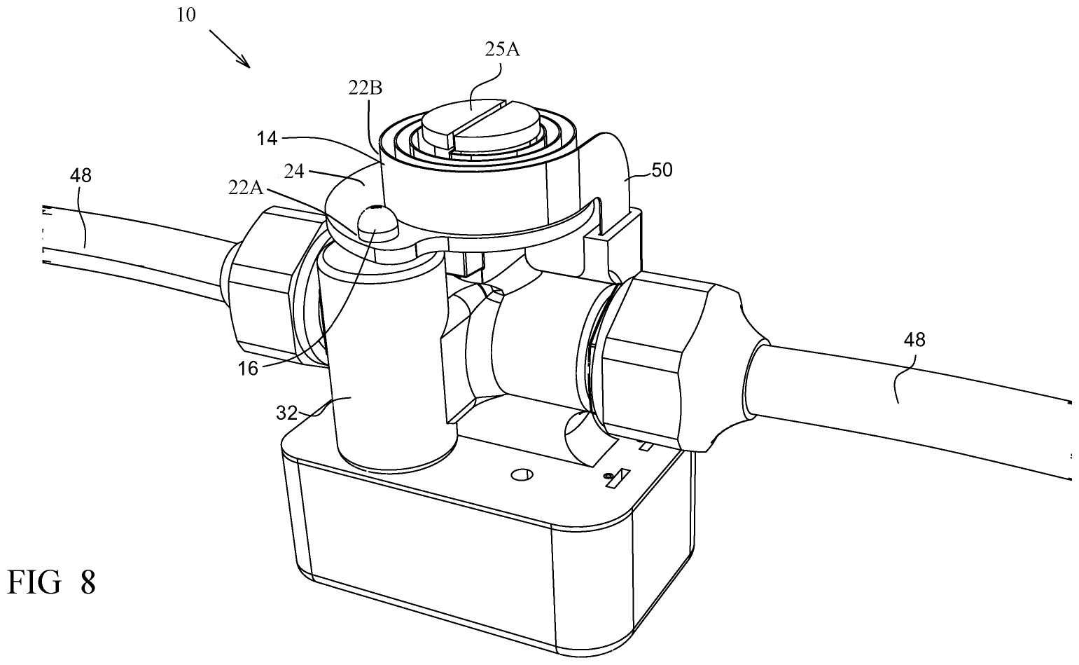

FIG. 8 depicts the LPG faucet according to another embodiment, at the open state.

Pin 16 is shown disposed within hole 22A of handle 24.

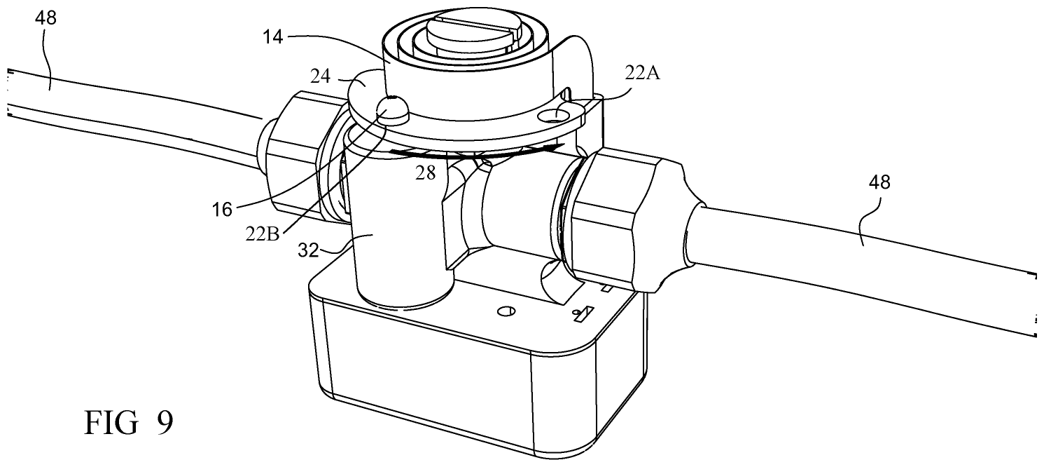

FIG. 9 depicts the LPG faucet of FIG. 8 at the closed state.

Pin 16 is shown disposed within hole 22B of handle 24.

Thus, in one aspect, the invention is directed to a liquefied petroleum gas (LPG) faucet (10), including:
a solenoid (32); and
an electric circuit (36), for sliding (26A) the solenoid (32);
   wherein opening the faucet (10) requires manual physical operation, whereas
   closing the faucet (10) is applicable only by controlling the electric circuit (36).

Controlling the electric circuit (36) to close the faucet (10) may be applied by remote control (30A) and a sensor (30B).

Controlling the electric circuit (36) to close the faucet (10) may be encoded (31).

The liquefied petroleum gas (LPG) faucet (10) may further include:
a spring (14), connected (25A) to an arm (24), connected (25B) to a pipe blocking element (62), the spring (14) being normally tensed to move (28) the arm (24) to dispose the pipe blocking element (62) to block a gas passage (21); and
a pin (16), being insertable into at least one hole (22A) of the arm (24) to lock the arm (24) at a disposition which the pipe blocking element (62) opens the gas passage (21),
   thereby opening the gas passage (21) requires manual physical motion of the arm (24) against the spring (24), and the closing the gas passage (21) is applicable only by controlling the circuit (36) to slide (26A) the solenoid (32) to remove (26A) the pin (16) from the at least one hole (22A) of the arm (24), for unlocking the arm (24) from the disposition which the pipe blocking element (62) opens the gas passage (21).

The at least one hole (22A) of the arm (24) may include a second hole (22B) for locking the arm (24) at a disposition which the pipe blocking element (62) closes the gas passage (21),
thereby opening the gas passage (21) is applicable by controlling the circuit (36) to slide (26A) the solenoid (32) to remove the pin (16) from the second hole (22B) of the arm (24), for unlocking the arm (24) from the disposition which the pipe blocking element (62) closes the gas passage (21), followed by the manual physical motion of the arm (24) against the spring (24).

In the figures and/or description herein, the following reference numerals (Reference Signs List) have been mentioned:
numeral 10 denotes the LPG faucet according to one embodiment of the invention;
12: antenna for receiving and transmitting wireless transmission 30A;
14: spring tensed to close the faucet;
16: pin for locking arm 24 to the closed or open state;
18: ring for attaching a device 27 to prior art faucet 23, such that the structure combined with prior art faucet 23 constitute LPG faucet 10;
21: gas passage within gas pipe 48;
22A: hole of arm 24, for locking arm 24 to the open state against spring 14, for maintaining the normal open state, while allowing remote closing, requiring minimal power;
22B: hole of arm 24, for locking arm 24 to the closed state, for not allowing unauthorized persons to open the faucet;
23: prior art faucet;
24: arm for moving pipe blocking element 62;
25A: connection of spring 24 to arm 24;
25B: connection of arm 24 to pipe blocking element 62;
26A,26B: sliding of pin 16;
27: device included in LPG faucet 10;
28: moving of arm 24 by spring 14;
30A: wireless transmission, for controlling solenoid 32;
30B: sensor, such as LPG leak sensor, for controlling solenoid 32 for automatically closing the faucet;
31: encoding such as password, required for transmitting wireless transmission 30A;
32: electro-mechanical device, such as solenoid or motor for sliding pin 16;
34: transceiver;
36: circuit for controlling solenoid 32;
38: battery, which may have low capacity, as being sufficient for slight sliding of solenoid 32;
42: cover;
48: gas pipe;
62: pipe blocking element;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A liquefied petroleum gas (LPG) faucet (10), comprising:
an electro-mechanical device (32) for sliding a pin (16); and
an electric circuit (36), for controlling said electro-mechanical device (32);
wherein opening said faucet (10) requires manual physical operation, whereas
closing said faucet (10) is applicable only by controlling said electric circuit (36).

2. The liquefied petroleum gas (LPG) faucet (10) according to claim 1, wherein said
said controlling said electric circuit (36) to close said faucet (10) comprises a member selected from a group consisting of: remote control (30A), a sensor (30B).

3. The liquefied petroleum gas (LPG) faucet (10) according to claim 1, wherein said
said controlling said electric circuit (36) to close said faucet (10) is encoded (31).

4. The liquefied petroleum gas (LPG) faucet (10) according to claim 1, further comprising:
a spring (14), connected (25A) to an arm (24), connected (25B) to a pipe blocking element (62), said spring (14) being normally tensed to move (28) said arm (24) to dispose said pipe blocking element (62) to block a gas passage (21); and
a pin (16), being insertable into at least one hole (22A) of said arm (24) to lock said arm (24) at a disposition which said pipe blocking element (62) opens said gas passage (21),
thereby said opening said gas passage (21) requires manual physical motion of said arm (24) against said spring (24), and
said closing said gas passage (21) is applicable only by controlling said circuit (36) to slide (26A) said pin (16) to remove (26A) thereof from said at least one hole (22A) of said arm (24), for unlocking said arm (24) from said disposition which said pipe blocking element (62) opens said gas passage (21).

5. The liquefied petroleum gas (LPG) faucet (10) according to claim 4, wherein said at least one hole (22A) of said arm (24) comprises a second hole (22B) for locking said arm (24) at a disposition which said pipe blocking element (62) closes said gas passage (21),
thereby said opening said gas passage (21) is applicable by controlling said circuit (36) to slide (26A) said electro-mechanical device (32) to remove said pin (16) from said second hole (22B) of said arm (24), for unlocking said arm (24) from said disposition which said pipe blocking element (62) closes said gas passage (21),
followed by said manual physical motion of said arm (24) against said spring (24).
